(19) United States
(12) Patent Application Publication
(10) Pub. No.: US 2011/0050692 A1
(43) Pub. Date: Mar. 3, 2011

(54) INTERPOLATING AND RENDERING SUB-PHASES OF A 4D DATASET

(75) Inventors: Kun Zhang, Sunnyvale, CA (US); Hui Zhang, Sunnyvale, CA (US); Bai Wang, Palo Alto, CA (US); Robert W. Hill, San Jose, CA (US)

(73) Assignee: ACCURAY INCORPORATED, Sunnyvale, CA (US)

(21) Appl. No.: 12/552,261

(22) Filed: Sep. 1, 2009

(51) Int. Cl. G06T 17/00

(52) U.S. Cl. 345/424

(57) ABSTRACT

A technique for rendering a deformable volume includes acquiring 3D images of a deformable volume including an object during phases of a deformation motion. The 3D images include voxels, a portion of which move from original coordinate locations during a primary phase to deformed coordinate locations during each subsequent phase of the deformation motion. Deformation matrixes each based upon one of the 3D images during a different one of the phases are generated. The deformation matrixes each include transformation vectors describing how to return the voxels from their deformed coordination locations to their original coordinate locations of the primary phase. A sub-phase 3D image of the deformable volume between consecutive phases is generated by interpolating between the transformation vectors of the consecutive phases associated with a given coordinate location within the deformable volume and retrieving voxel data from a primary 3D image at voxel locations referenced by interpolated transformation vectors.

### TECHNICAL FIELD

This disclosure relates generally to volume rendering, and in particular but not exclusively, relates to animated volume rendering using deformation data.

### BACKGROUND

Volume rendering enables three-dimensional (3D) volumetric data to be visualized. Volumetric data may consist of a 3D array of voxels, each voxel characterized by an intensity value which may scale via a filter function to color and opacity. As such, each voxel may be assigned a color (e.g., one of R (red), G (green), and B (blue)) and opacity, and a 2D projection of the volumetric data may be computed. Using volume rendering techniques, a viewable 2D image may be derived from the 3D volumetric data.

Volume rendering is widely used in many applications to derive a viewable 2D image from 3D volumetric data of an object, e.g. a target region within a patient's anatomy. The 2D image may be a 2D projection through 3D volumetric data to generate digitally reconstructed radiographs facilitating 2D-3D image registration and real-time image-guided radiosurgery referenced to the 3D volumetric data. In medical applications such as radiosurgery, an anatomical target region that moves, due to e.g. heartbeat or breathing of the patient, may need to be tracked. In these cases, a volume rendered animation of periodic motions such as respiration and heartbeat may be desirable.

A 3D volume dataset which varies over time may be considered to be a 4D deformable volume image. A number of methods may be used for volume rendering of 4D deformable volume images. These methods may involve one or more of the following approaches: representing a deformable volume using tetrahedrons that have freedom to move in 3D space; using a marching cube algorithm to convert volume rendering to surface rendering by finding small iso-surfaces in non-structural data; representing the volumetric dataset with a procedural mathematical function; or using a multiple volume switching method, in which all the intermediate volumes are generated before rendering.

Many of these approaches tend to be very time-consuming, and some require vast stores of memory. Some of these approaches do not lend themselves well for medical images, while some of these approaches are difficult to obtain smooth transitions between stages.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates 3-dimensional (“3D”) images of a volume captured during different phases of deformation of an object within the volume and how voxels within the object migrate from their original coordinates locations during the deformation, in accordance with an embodiment of the invention.

FIG. 2A (Prior Art) illustrates geometric based interpolation between phases of deformation of an object.

FIG. 2B illustrates a content based interpolation between phases of deformation of an object, in accordance with an embodiment of the invention.

FIG. 3 is a flow chart illustrating a process for 4-dimensional (4D) volume rendering, in accordance with an embodiment of the invention.

FIG. 4 is a functional block diagram illustrating a 4D volume rendering pipeline, in accordance with an embodiment of the invention.

FIG. 5 is a flow chart illustrating a process for content based interpolation between consecutive phases of a 4D dataset, in accordance with an embodiment of the invention.

FIG. 6 illustrates an example sub-phase interpolation of a single voxel between phases 2 and 3 of a 4D dataset, in accordance with an embodiment of the invention.

FIG. 7 is a functional block diagram illustrating a patient treatment system for generating diagnostic images, generating a treatment plan, and delivering the treatment plan, in accordance with an embodiment of the invention.

FIG. 8 is a perspective view of a radiation treatment delivery system, in accordance with an embodiment of the invention.

### DETAILED DESCRIPTION

Embodiments of a system and method for 4-dimensional (4D) volume rendering are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

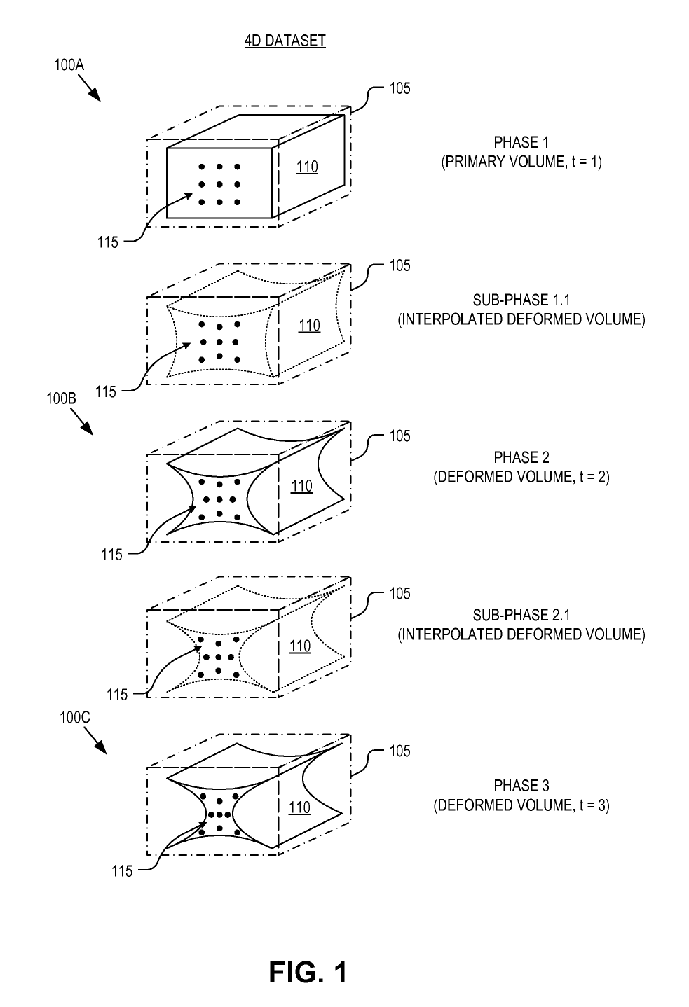

FIG. 1 illustrates 3-dimensional (“3D”) images 100A-C of a volume 105 captured during different phases of deformation of an object 110 within volume 105 and how voxels 115 within volume 105 migrate from their original coordinates locations during the deformation. FIG. 1 may be thought of as illustrating a 4D dataset where the fourth dimension represents time. Each 3D image 100 captures volume 105 at a different time or phase (e.g., phase 1, phase 2, and phase 3) during the deformation motion of object 110. Volume 105 may also be referred to a “deformable volume” while the collection of 3D images 100 may be referred to as a “deformable volume dataset.”

As illustrated, during each phase voxels 115 migrate or deform from their original coordinate location within volume 105 to a deformed coordinate location. The selection of the “original” coordinate location may be an arbitrary choice, particularly if the deformation motion is a cyclical motion. In the illustrated embodiment, the original coordinate locations are deemed to occur during phase 1 (e.g., time t=1), which is also referred to as the primary volume 105, primary 3D image 100A, or primary phase. The subsequent phases (e.g., phases 2 or 3) are referred to as deformed phases, deformed volumes 105, or deformed 3D images 100.

Capturing and rendering a 4D dataset may have a variety of applications. In the medical profession, these operations are useful for image guided radiotherapy procedures. For example, volume 105 may represent a volume within the rib cage of a human patient, while object 110 may represent a heart deforming during the cardiac phases of motion. Alternatively, object 110 may represent a tumor within a patient which deforms during respiratory motion or cardiac motion. Each voxel 115 may represent a 3D data point or pixel including an intensity value. The intensity values may also be represented as RGBA (red, green, blue, alpha) data with the “alpha” representing an opacity value.

If the time lapse between consecutive or sequential phases 1, 2, 3 is sufficiently large, a rendering of object 110 may appear jittery. For image guided radiotherapy applications, it may be desirable to closely track the deformation of object 110, even between captured 3D images 100A-C. Embodiments of the invention enables the generation of sub-phases (e.g., sub-phase 1.1, sub-phase 2.1, etc.) interpolated between consecutive phases 100A-C. By interpolating voxel data between consecutive phases, the number of 3D data images in a 4D dataset can be increased to reduce jitter and increase the quality and accuracy of the 4D dataset.

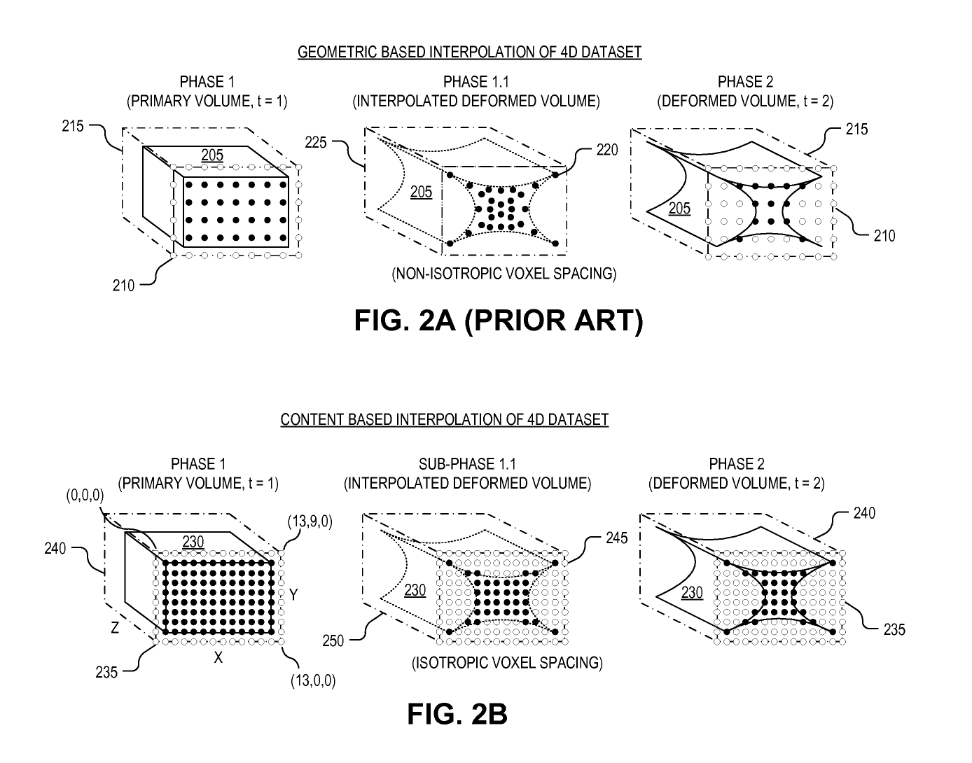

FIG. 2A illustrates a conventional geometric based interpolation technique between phases of deformation of an object 205. Phase 1 and phase 2 represent 3D images that were captured during the deformation motion of object 205. This data may be captured using X-ray imaging, computed tomography (“CT”), magnetic resonance imaging (“MRI”), positron emission tomography (“PET”), or other 3D imaging modalities. As such, the captured 3D images have voxels 210 evenly spaced throughout the volume 215 during phases 1 and 2. However, the geometric based interpolation uses geometric principles to interpolate voxels 220 of sub-phase 1.1. The geometric principles do not preserve isotropic voxel spacing. Rather, some regions within the interpolated volume 225 end up with a thinning of interpolated voxels 220 resulting in low resolution localities. It may be undesirable, if the deformable object of interest (e.g., tumor) happens to fall within a low resolution locality of the interpolated volume 225. The conventional geometric based interpolation is forward looking, using voxels from future phases to interpolate voxels of an earlier in time sub-phase.

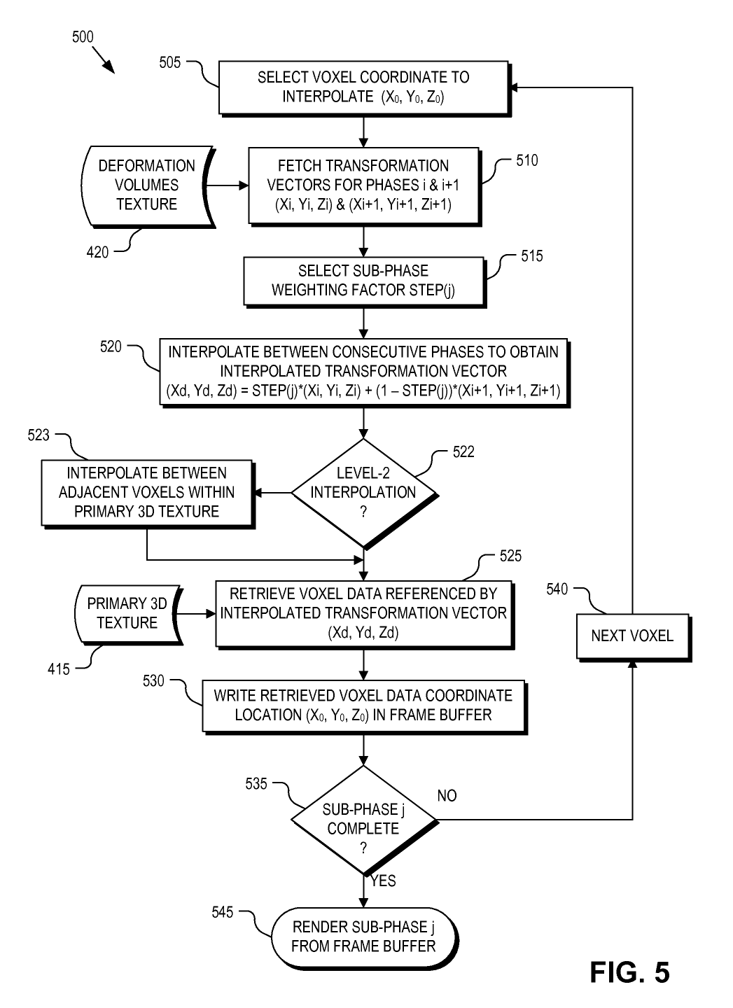

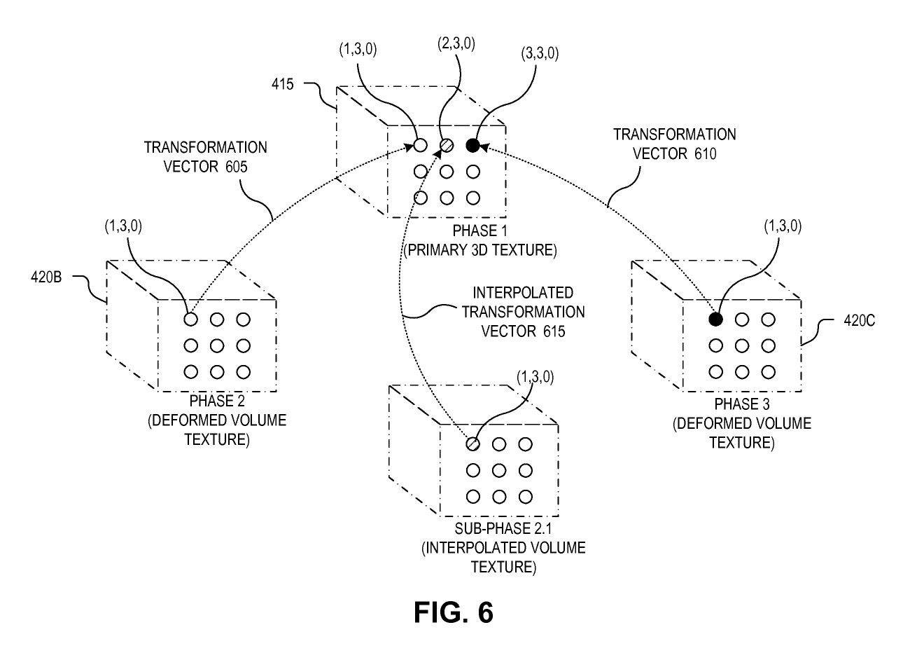

FIG. 2B illustrates a content based interpolation between consecutive phases of deformation of object 230, in accordance with an embodiment of the invention. Again, phase 1 and phase 2 represent 3D images that were captured during the deformation motion of object 230. This data may be captured using X-ray imaging, CT scanning, MRI imaging, PET scanning or other 3D imaging modalities. As such, the captured 3D images have voxels 235 evenly spaced throughout the volume 240 during phases 1 and 2. However, the content based interpolation uses the content or dataset itself to interpolate voxels 245 of sub-phase 1.1. The content interpolation preserves isotropic voxel spacing, as discussed in detail below in connection with FIGS. 5 and 6. As such, the interpolated deformed volume 250 is significantly more uniform and substantially eliminates high and low resolution localities. Rather, the voxel resolution, pitch, or spacing is substantially consistent throughout the interpolated volume providing a high quality, more uniform interpolated dataset. Content based interpolation is backward looking, using voxels from an earlier in-time phase (e.g., phase 1) to interpolate voxels in a future occurring sub-phase (e.g., sub-phase 1.1).

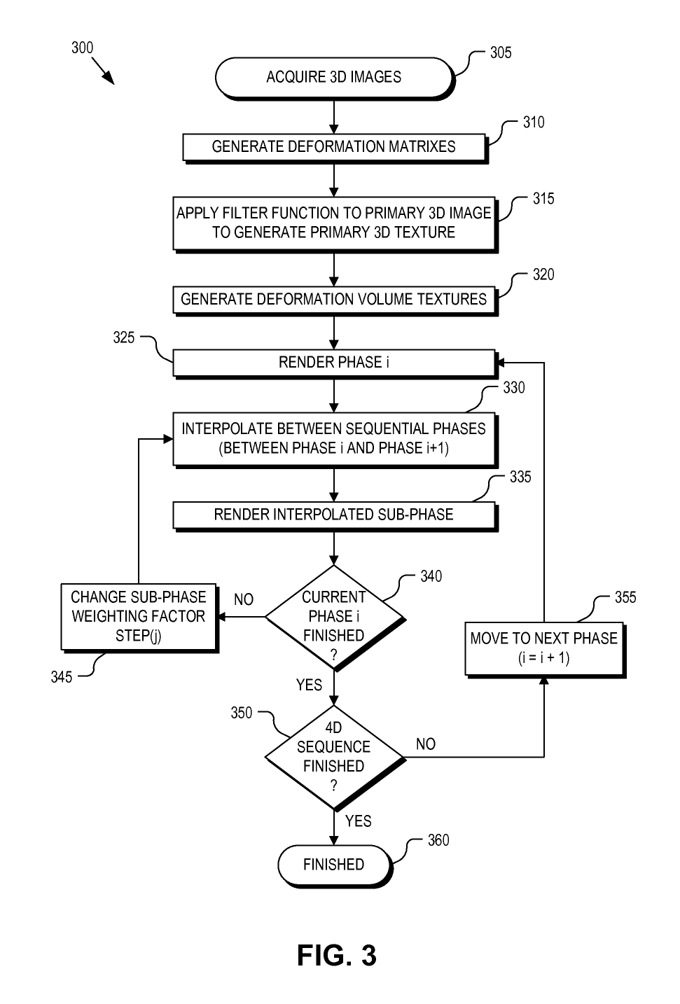

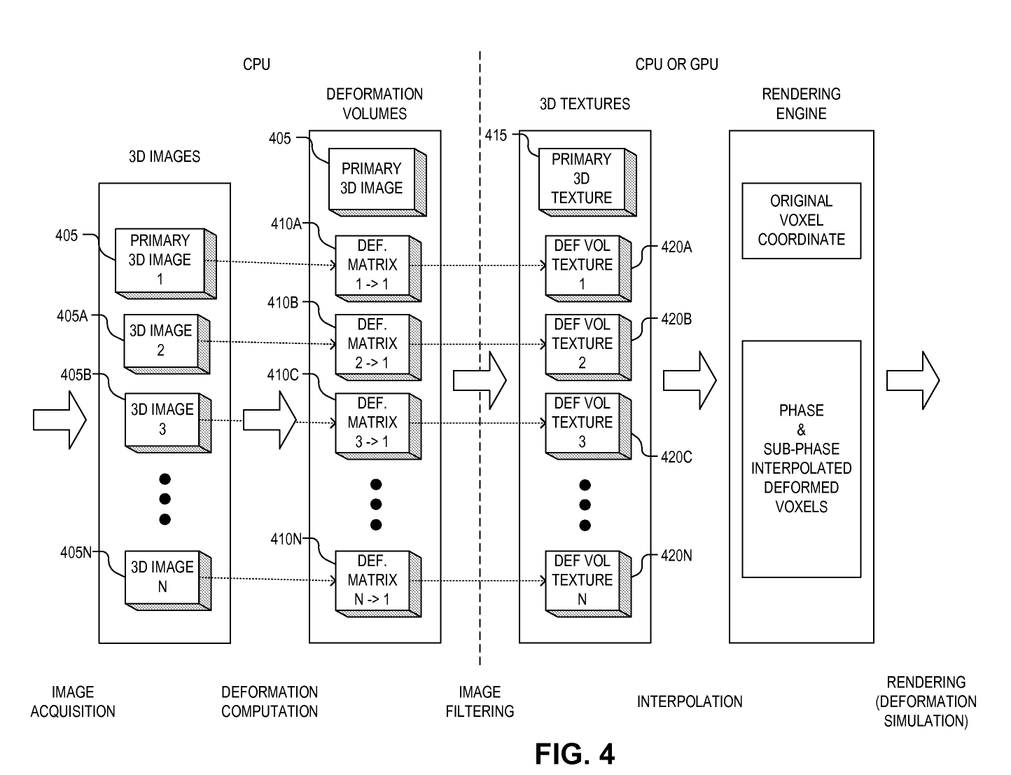

FIG. 3 is a flow chart illustrating a process 300 for 4D volume rendering, in accordance with an embodiment of the invention. Process 300 is explained with reference to FIG. 4. The order in which some or all of the process blocks appear in process 300 should not be deemed limiting. Rather, one of ordinary skill in the art having the benefit of the present disclosure will understand that some of the process blocks may be executed in a variety of orders not illustrated.

In process block 305, 3D images 405 of a deformable volume including an object in deformation motion are acquired. 3D images 405 may be acquired using a variety of imaging modalities, such as, CT scanning, x-ray imaging, MRI imaging, PET scanning, or otherwise. One of the 3D images 405 is selected or designated as the primary 3D image or primary volume. In one embodiment, the primary 3D image is scanned or otherwise acquired to have a higher voxel resolution than the other 3D images.

In process block 310, a deformation computation is executed to generate deformation matrixes 410. In one embodiment, a separate deformation matrix 410 is generated for each 3D image 405, including the primary 3D image. In one embodiment, deformation matrixes 410 are each a matrix of transformation vectors. Each transformation vector corresponds to a given voxel within its corresponding 3D image 405. In other words, each transformation vector corresponds to a voxel at a deformed coordinate location within volume 105 or 240. Furthermore, each transformation vector describes, with reference to the primary 3D image, from where the given voxel was deformed. In other words, each transformation vector describes how to return a given voxel from its deformed coordinate location to its original coordinate location within the primary 3D image prior to the deformation motion. In one embodiment, deformation matrixes 410 are 3D matrixes of transformation vectors, which are in turn deformation coordinates (e.g., X, Y, Z coordinates, polar coordinates, or otherwise) that reference or point back to their original coordinate location within primary 3D image 405. For example, a transformation vector located at deformed coordinate location (1,2,1) of deformation matrix 410C having a value of (1,3,0) indicates that the voxel at deformed coordinate location (1,2,1) in 3D image 405B originated at original coordinate location 1,3,0 in primary 3D image 405. In one embodiment, deformation matrix 410A is an identify matrix, since deformation matrix 410A corresponds to primary 3D image 405. The deformation computation may be executed to generate deformation matrixes 410 using a variety of algorithms, such as and without limitation, B-Spline transformations, linear transformations.

In process block 315, image filtering is applied to primary 3D image 405 to generate primary 3D texture 415. For example and without limitation, the filter function applied by the image filtering transforms intensity values of primary 3D image 405 into RGBA values and filters out portions of 3D image 405 not of interest. The remaining RGBA values not filtered out by the filter function may correspond to a texture surface of interest. For example, if primary 3D image 405 is an image of a human anatomy, image filtering may be used to filter out soft tissue to display bone structure, or filter out healthy tissue to display a tumor. In one embodiment, the filter function is executed by a CPU. In another embodiment, the filter function is executed by a GPU after primary 3D image 405 is transferred into a GPU memory buffer. In yet another embodiment, the intensity values of primary 3D image 405 are not converted into RGBA values at all; but rather, the intensity values themselves are filtered for values or textures of interest and primary 3D texture 415 is represented as textured or filtered intensity values, as opposed to textured or filtered RGBA values. In yet another embodiment, the unfiltered intensity values of primary 3D image 405 are transferred straight into the GPU without modification.

In process block 320, deformation volume textures 420 are generated based on their corresponding deformation matrixes 410. In one embodiment, deformation volume textures 420 are created by transferring the deformation coordinates of each transformation vector into an RGB buffer of the GPU. In this embodiment, the three X, Y, Z coordinates of the transformation vector are stored into the three R, G, B, buffers, respectively (or some combination thereof). Loading the deformation coordinates into RGB buffers of the GPU leverages the parallelism of the GPU (e.g., a GPU may include 128 parallel image processors capable of operating on 128 transformation vectors in parallel) to provide hardware acceleration of the texturing and rendering process.

Once primary 3D texture 415 and the first set of transformation vectors have been loaded into the RGB buffers of the GPU, then rendering of phase (i) can commence. It should be appreciated that the GPU operates on one deformation matrix 410 at a time. For example, in the case of a GPU having a 128 parallel image processors, the first 128 transformation vectors of deformation matrix 410A are loaded into the GPU, processed, and the results loaded into a frame buffer for eventual rendering to a display. Then, the next 128 transformation vectors of deformation matrix 410A are loaded, processed, and output to the frame buffer, and so on, until an entire 3D image has been processed and loaded into the frame buffer of the GPU and ready for rendering (process block 325). Again, it should be appreciated that all processing steps described above, except for the final rendering, can be executed by the CPU, though without leveraging the parallelism provided by the GPU.

To increase the number of 3D image frames in a 4D dataset, one or more sub-phases may be interpolated between consecutive phases (i) using the content of deformation volume textures 420 (or deformation matrixes 410) themselves. In a process block 330, interpolation between the transformation vectors associated with a given voxel at a given deformation coordinate location for both phases (i) and (i+1) is executed. In one embodiment, this interpolation is executed by taking a weighted average of the transformation vectors at the given deformation coordinate locations for the two consecutive phases. This interpolation is repeated for all voxels within the deformation volume textures of a pair of consecutive phases (i) and (i+1). Once a complete deformation volume texture of a given sub-phase has been completed, it may be rendered from the frame buffer (process block 335).

As mentioned above, multiple sub-phases may be interpolated between consecutive phases by adjusting a weighting factor, step (j), for each sub-phase interpolated (process block 345). The weighting factor skews the interpolation bias in selected increments (e.g., for ten sub-phases, the weighting factor could be incremented from 0 to 1.0 in 0.1 increments for each sub-phase) from the earlier phase to the later phase of the two consecutive phases. The interpolation, rendering, and weighting factor are described in further detail below in connection with FIGS. 5 and 6.

Once all the sub-phases between a given set of consecutive phases (i) and (i+1) have been interpolated (decision block 340), process 300 increments to the next set of consecutive phases (i+1) and (i+2) (process block 355) to interpolate sub-phases there between as described above. Finally, once the entire 4D dataset has been rendered, including all sub-phases interpolated and rendered (decision block 350), process 300 is completed at termination block 360.

FIG. 5 is a flow chart illustrating a process 500 for content based interpolation between consecutive phases of a 4D dataset, in accordance with an embodiment of the invention. Process 500 is explained with reference to FIG. 6. FIG. 6 illustrates the interpolation of a sub-phase 2.1 between phase 2 and phase 3 of a 4D dataset. The order in which some or all of the process blocks appear in process 500 should not be deemed limiting. Rather, one of ordinary skill in the art having the benefit of the present disclosure will understand that some of the process blocks may be executed in a variety of orders not illustrated.

In process block 505, a voxel coordinate (X₀, Y₀, Z₀) is selected for interpolation. In the example of FIG. 6, the selected voxel is the voxel at coordinate location (1,3,0). In process block 510, the transformation vectors at the selected voxel coordinate are retrieved from the two consecutive deformation volume textures 420 (or deformation matrixes 410 if interpolation is performed by the CPU) of phases (i) and (i+1). In accordance with the example illustrated in FIG. 6, the two transformation vectors, which are located at voxel coordinate (1,3,0) within deformation volume textures 420B and 420C are fetched (see FIG. 4). In process block 515, the weighting factor, step (j), is selected for the instant sub-phase 2.1 being interpolated. Step (j) is a value between 0 and 1 and is incremented for each sub-phase interpolated between consecutive phases (i) and (i+1). For example, for sub-phase 2.1, step (j) may equal 0.1.

In process block 520, the two transformation vectors from the consecutive phases are interpolated to generate an interpolated transformation vector. In one embodiment, interpolation is performed according to equation (1),

(X_{d},Y_{d},Z_{d})=step(j)*(Xᵢ,Yᵢ,Zᵢ)+(1−step(j))*(Xᵢ₊₁,Yᵢ₊₁,Zᵢ₊₁), (1)

where (X_{d}, Y_{d}, Z_{d}) represents the interpolated transformation vector for the selected coordinate location (X₀, Y₀, Z₀), step(j) represents the weighting factor, (Xᵢ, Yᵢ, Zᵢ) represents the transformation vector at coordinate location (X₀, Y₀, Z₀) for phase (i), and (Xᵢ₊₁, Yᵢ₊₁, Zᵢ₊₁) represents the transformation vector at coordinate location (X₀, Y₀, Z₀) for phase (i+1). Referring to FIG. 6, (Xᵢ, Yᵢ, Zᵢ) corresponds to transformation vector 605 and (Xᵢ₊₁, Yᵢ₊₁, Zᵢ₊₁) corresponds to transformation vector 610, and (X_{d}, Y_{d}, Z_{d}) corresponds to interpolated transformation vector 615.

Once the interpolated transformation vector has been generated, voxel data is retrieved from primary 3D texture 415 with reference to the interpolated transformation vector (process block 525). However, if the interpolated transformation vector references back to an intermediate position between adjacent voxels within primary 3D texture 415, then a second level of interpolation may be executed (decision block 522). In this situation, the voxel data associated with the adjacent voxels within primary 3D texture 415 is interpolated to obtain averaged voxel data, which is then retrieved in process block 525. Referring to the example of FIG. 6, if interpolated transformation vector 615 referenced back to a midpoint between coordinate location (1,3,0) and (2,3,0), then the voxel data associated with the voxels at these two coordinate locations may be simply averaged. In other embodiments, a weighted average or continuous interpolation between horizontally, vertically, and diagonally adjacent voxels may be implemented. Of course, other types of interpolation or averaging may be implemented between adjacent voxels.

In one embodiment, the voxel data is texture data (e.g., RGBA values) pointed to by the interpolated transformation vector and retrieved from primary 3D texture 415. In an embodiment wherein primary 3D image 405 is not filtered, the voxel data is an intensity value pointed to by the interpolated transformation vector and retrieved from primary 3D image 405 in process block 525.

Referring again to the example of FIG. 6, it can be seen that transformation vector 605 of phase 2 originates from a coordinate location (1,3,0) during phase 2 and references back to the same coordinate location (1,3,0) within phase 1. This means that the voxel at coordinate location (1,3,0) during phase 1 did not move during the deformation motion that occurred between phases 1 and 2. However, transformation vector 610 of phase 3 also originates from the coordinate location (1,3,0) within the deformation volume during phase 3, but references back to coordinate location (3,3,0) in phase 1. This means that the voxel originally located at coordinate location (3,3,0) has deformed or migrated to coordinate location (1,3,0) by phase 3 of the deformation motion. By interpolating between (e.g., taking a weighted average) transformation vectors 605 and 610, it is determined that the voxel at coordinate location (1,3,0) during the interpolated sub-phase 2.1 may have originated at the intermediate coordinate location (2,3,0) during phase 1. Once interpolated transformation vector 615 is generated, it is referenced to fetch the texture data or intensity value associate with the voxel originally located at coordinate location (2,3,0) during phase 1. This is illustrated graphically for all three phases 2, 2.1, and 3 with shading. It should be appreciated that in some embodiments, primary 3D image 405 or primary 3D texture 415 may have significantly higher resolutions than the other 3D images to improve the granularity of the sub-phase interpolations.

In a process block 530, the retrieved voxel data is written into the frame buffer for the current sub-phase being generated at the voxel coordinate selected in process block 505. Process 500 continues to loop for each voxel coordinate within the volume 250 (process block 540) until all voxel data has been retrieved and the frame buffer filled with a complete 3D image (decision block 535). Finally, in a process block 545 the current sub-phase (j) can be rendered from the frame buffer to a display screen.

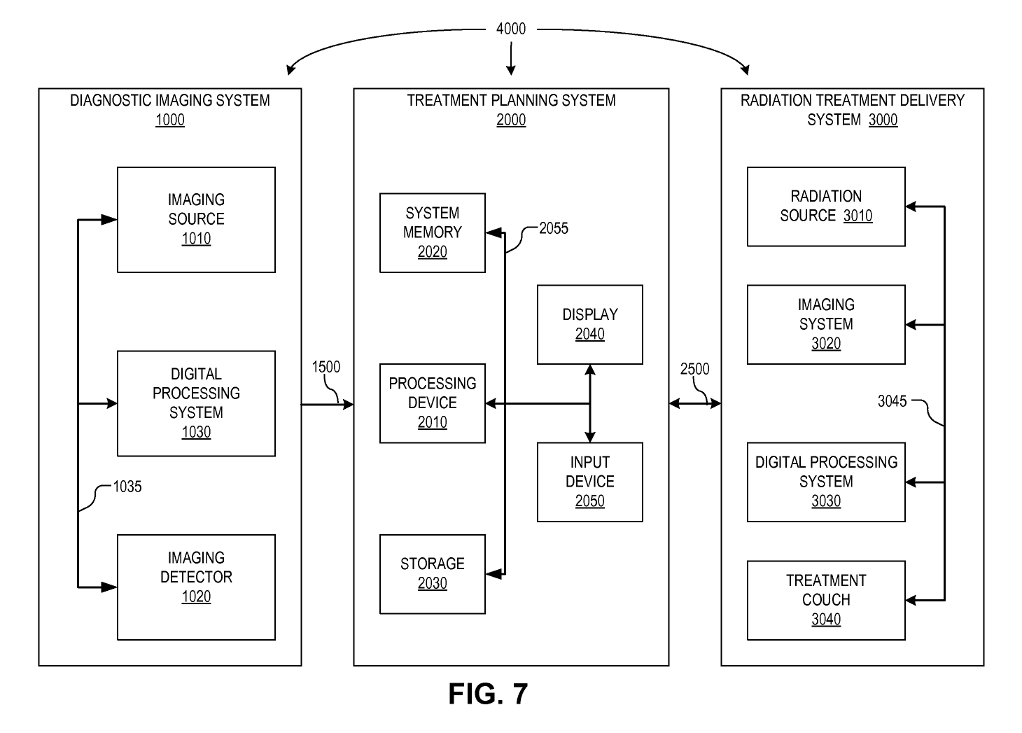

FIG. 7 is a block diagram illustrating a therapeutic patient treatment system 4000 for generating diagnostic images, generating a treatment plan, and delivering the treatment plan to a patient, in which features of the present invention may be implemented. As described below and illustrated in FIG. 7, system 4000 may include a diagnostic imaging system 1000, a treatment planning system 2000 and a radiation delivery system 3000.

Diagnostic imaging system 1000 may be any system capable of producing medical diagnostic images of the VOI within a patient that may be used for subsequent medical diagnosis, treatment planning and/or treatment delivery. For example, diagnostic imaging system 1000 may be a computed tomography (“CT”) system, a magnetic resonance imaging (“MRI”) system, a positron emission tomography (“PET”) system, an ultrasound system or the like. For ease of discussion, diagnostic imaging system 1000 may be discussed below at times in relation to a CT x-ray imaging modality. However, other imaging modalities such as those above may also be used. In one embodiment, diagnostic imaging system 1000 may be used to generate 3D dataset 235.

Diagnostic imaging system 1000 includes an imaging source 1010 to generate an imaging beam (e.g., x-rays, ultrasonic waves, radio frequency waves, etc.) and an imaging detector 1020 to detect and receive the beam generated by imaging source 1010, or a secondary beam or emission stimulated by the beam from the imaging source (e.g., in an MRI or PET scan). In one embodiment, diagnostic imaging system 1000 may include two or more diagnostic X-ray sources and two or more corresponding imaging detectors. For example, two x-ray sources may be disposed around a patient to be imaged, fixed at an angular separation from each other (e.g., 90 degrees, 45 degrees, etc.) and aimed through the patient toward (an) imaging detector(s) which may be diametrically opposed to the x-ray sources. A single large imaging detector, or multiple imaging detectors, can also be used that would be illuminated by each x-ray imaging source. Alternatively, other numbers and configurations of imaging sources and imaging detectors may be used.

The imaging source 1010 and the imaging detector 1020 are coupled to a digital processing system 1030 to control the imaging operation and process image data. Diagnostic imaging system 1000 includes a bus or other means 1035 for transferring data and commands among digital processing system 1030, imaging source 1010 and imaging detector 1020. Digital processing system 1030 may include one or more general-purpose processors (e.g., a microprocessor), special purpose processor such as a digital signal processor (“DSP”) or other type of device such as a controller or field programmable gate array (“FPGA”). Digital processing system 1030 may also include other components (not shown) such as memory, storage devices, network adapters and the like. Digital processing system 1030 may be configured to generate digital diagnostic images in a standard format, such as the DICOM (Digital Imaging and Communications in Medicine) format, for example. In other embodiments, digital processing system 1030 may generate other standard or non-standard digital image formats. Digital processing system 1030 may transmit diagnostic image files (e.g., the aforementioned DICOM formatted files) to treatment planning system 2000 over a data link 1500, which may be, for example, a direct link, a local area network (“LAN”) link or a wide area network (“WAN”) link such as the Internet. In addition, the information transferred between systems may either be pulled or pushed across the communication medium connecting the systems, such as in a remote diagnosis or treatment planning configuration. In remote diagnosis or treatment planning, a user may utilize embodiments of the present invention to diagnose or treatment plan despite the existence of a physical separation between the system user and the patient.

Treatment planning system 2000 includes a processing device 2010 to receive and process image data. Processing device 2010 may represent one or more general-purpose processors (e.g., a microprocessor), special purpose processor such as a DSP or other type of device such as a controller or FPGA. Processing device 2010 may be configured to execute instructions for performing treatment planning operations discussed herein.

Treatment planning system 2000 may also include system memory 2020 that may include a random access memory (“RAM”), or other dynamic storage devices, coupled to processing device 2010 by bus 2055, for storing information and instructions to be executed by processing device 2010. System memory 2020 also may be used for storing temporary variables or other intermediate information during execution of instructions by processing device 2010. System memory 2020 may also include a read only memory (“ROM”) and/or other static storage device coupled to bus 2055 for storing static information and instructions for processing device 2010.

Treatment planning system 2000 may also include storage device 2030, representing one or more storage devices (e.g., a magnetic disk drive or optical disk drive) coupled to bus 2055 for storing information and instructions. Storage device 2030 may be used for storing instructions for performing the treatment planning steps discussed herein.

Processing device 2010 may also be coupled to a display device 2040, such as a cathode ray tube (“CRT”) or liquid crystal display (“LCD”), for displaying information (e.g., a 2D or 3D representation of the VOI) to the user. An input device 2050, such as a keyboard, may be coupled to processing device 2010 for communicating information and/or command selections to processing device 2010. One or more other user input devices (e.g., a mouse, a trackball or cursor direction keys) may also be used to communicate directional information, to select commands for processing device 2010 and to control cursor movements on display 2040.

It will be appreciated that treatment planning system 2000 represents only one example of a treatment planning system, which may have many different configurations and architectures, which may include more components or fewer components than treatment planning system 2000 and which may be employed with the present invention. For example, some systems often have multiple buses, such as a peripheral bus, a dedicated cache bus, etc. The treatment planning system 2000 may also include MIRIT (Medical Image Review and Import Tool) to support DICOM import (so images can be fused and targets delineated on different systems and then imported into the treatment planning system for planning and dose calculations), expanded image fusion capabilities that allow the user to treatment plan and view dose distributions on any one of various imaging modalities (e.g., MRI, CT, PET, etc.). Treatment planning systems are known in the art; accordingly, a more detailed discussion is not provided.

Treatment planning system 2000 may share its database (e.g., data stored in storage device 2030) with a treatment delivery system, such as radiation treatment delivery system 3000, so that it may not be necessary to export from the treatment planning system prior to treatment delivery. Treatment planning system 2000 may be linked to radiation treatment delivery system 3000 via a data link 2500, which may be a direct link, a LAN link or a WAN link as discussed above with respect to data link 1500. It should be noted that when data links 1500 and 2500 are implemented as LAN or WAN connections, any of diagnostic imaging system 1000, treatment planning system 2000 and/or radiation treatment delivery system 3000 may be in decentralized locations such that the systems may be physically remote from each other. Alternatively, any of diagnostic imaging system 1000, treatment planning system 2000 and/or radiation treatment delivery system 3000 may be integrated with each other in one or more systems.

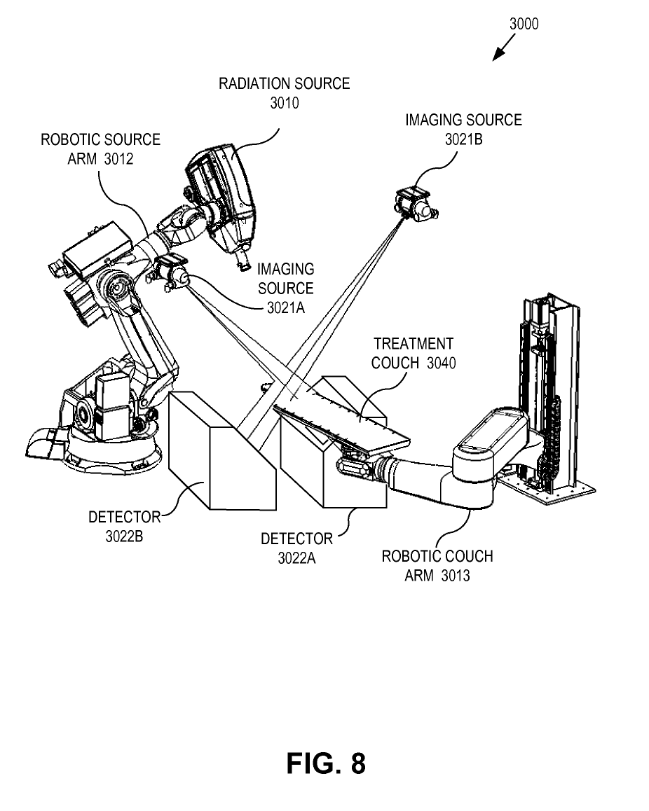

Radiation treatment delivery system 3000 includes a therapeutic and/or surgical radiation source 3010 to administer a prescribed radiation dose to a target volume in conformance with a treatment plan. Radiation treatment delivery system 3000 may also include an imaging system 3020 (including imaging sources 3021 and detectors 3022, see FIG. 8) to capture inter-treatment images of a patient volume (including the target volume) for registration or correlation with the diagnostic images (e.g., DRR image 205) described above in order to position the patient with respect to the radiation source. Radiation treatment delivery system 3000 may also include a digital processing system 3030 to control radiation source 3010, imaging system 3020, and a patient support device such as a treatment couch 3040. Digital processing system 3030 may include one or more general-purpose processors (e.g., a microprocessor), special purpose processor such as a DSP or other type of device such as a controller or FPGA. Digital processing system 3030 may also include other components (not shown) such as memory, storage devices, network adapters and the like. Digital processing system 3030 may be coupled to radiation source 3010, imaging system 3020 and treatment couch 3040 by a bus 3045 or other type of control and communication interface.

FIG. 8 is a perspective view of a radiation delivery system 3000, in accordance with an embodiment of the invention. In one embodiment, radiation treatment delivery system 3000 may be an image-guided, robotic-based radiation treatment system such as the CyberKnife® system developed by Accuray, Inc. of California. In FIG. 8, radiation source 3010 may be a linear accelerator (“LINAC”) mounted on the end of a source positioning system 3012 (e.g., robotic arm) having multiple (e.g., 5 or more) degrees of freedom in order to position the LINAC to irradiate a pathological anatomy (target region or volume) with beams delivered from many angles in an operating volume (e.g., a sphere) around the patient. Treatment may involve beam paths with a single isocenter (point of convergence), multiple isocenters, or with a non-isocentric approach (i.e., the beams need only intersect with the pathological target volume and do not necessarily converge on a single point, or isocenter, within the target). Treatment can be delivered in either a single session (mono-fraction) or in a small number of sessions (hypo-fractionation) as determined during treatment planning. With radiation treatment delivery system 3000, in one embodiment, radiation beams may be delivered according to the treatment plan without fixing the patient to a rigid, external frame to register the intra-operative position of the target volume with the position of the target volume during the pre-operative treatment planning phase.

Imaging system 3020 (see FIG. 7) may be represented by imaging sources 3021A and 3021B and imaging detectors (imagers) 3022A and 3022B in FIG. 8. In one embodiment, imaging sources 3021A and 3021B are X-ray sources. In one embodiment, for example, two imaging sources 3021A and 3021B may be nominally aligned to project imaging x-ray beams through a patient from two different angular positions (e.g., separated by 90 degrees, 45 degrees, etc.) and aimed through the patient on treatment couch 3040 toward respective detectors 3022A and 3022B. In another embodiment, a single large imager can be used that would be illuminated by each x-ray imaging source. Alternatively, other numbers and configurations of imaging sources and detectors may be used.

Digital processing system 3030 may implement algorithms to register images obtained from imaging system 3020 with pre-operative treatment planning images (e.g., DRR image 205) in order to align the patient on the treatment couch 3040 within radiation treatment delivery system 3000, and to precisely position radiation source 3010 with respect to the target volume. Embodiments of the present invention may use the 4D imaging and interpolation techniques described above to aid in the image guidance and tracking of radiation treatment delivery system 3000.

In the illustrated embodiment, treatment couch 3040 is coupled to a couch positioning system 3013 (e.g., robotic couch arm) having multiple (e.g., 5 or more) degrees of freedom. Couch positioning system 3013 may have five rotational degrees of freedom and one substantially vertical, linear degree of freedom. Alternatively, couch positioning system 3013 may have six rotational degrees of freedom and one substantially vertical, linear degree of freedom or at least four rotational degrees of freedom. Couch positioning system 3013 may be vertically mounted to a column or wall, or horizontally mounted to pedestal, floor, or ceiling. Alternatively, treatment couch 3040 may be a component of another mechanical mechanism, such as the Axum™ treatment couch developed by Accuray, Inc. of California, or be another type of conventional treatment table known to those of ordinary skill in the art.

Alternatively, radiation treatment delivery system 3000 may be another type of treatment delivery system, for example, a gantry based (isocentric) intensity modulated radiotherapy (“IMRT”) system or 3D conformal radiation treatments. In a gantry based system, a therapeutic radiation source (e.g., a LINAC) is mounted on the gantry in such a way that it rotates in a plane corresponding to an axial slice of the patient. Radiation is then delivered from several positions on the circular plane of rotation. In IMRT, the shape of the radiation beam is defined by a multi-leaf collimator that allows portions of the beam to be blocked, so that the remaining beam incident on the patient has a pre-defined shape. The resulting system generates arbitrarily shaped radiation beams that intersect each other at the isocenter to deliver a dose distribution to the target. In IMRT planning, the optimization algorithm selects subsets of the main beam and determines the amount of time that the patient should be exposed to each subset, so that the prescribed dose constraints are best met.

It should be noted that the methods and apparatus described herein are not limited to use only with medical diagnostic imaging and treatment. In alternative embodiments, the methods and apparatus herein may be used in applications outside of the medical technology field, such as industrial imaging and non-destructive testing of materials (e.g., motor blocks in the automotive industry, airframes in the aviation industry, welds in the construction industry and drill cores in the petroleum industry) and seismic surveying. In such applications, for example, “treatment” may refer generally to the application of radiation beam(s).

The processes explained above are described in terms of computer software and hardware. The techniques described may constitute machine-executable instructions embodied within a machine (e.g., computer) readable storage medium, that when executed by a machine will cause the machine to perform the operations described. Additionally, the processes may be embodied within hardware, such as an application specific integrated circuit (“ASIC”) or the like.

A computer-readable storage medium includes any mechanism that provides (i.e., stores) information in a form accessible by a machine (e.g., a computer, network device, personal digital assistant, manufacturing tool, any device with a set of one or more processors, etc.). For example, a computer-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of volume rendering a deformable volume dataset representative of an object in deformation motion, the method comprising:
acquiring a plurality of 3-dimensional (“3D”) images of a deformable volume including the object during phases of the deformation motion, the 3D images including voxels, wherein a portion of the voxels move from original coordinate locations during a primary phase to deformed coordinate locations during each subsequent phase of the deformation motion;
generating deformation matrixes each based upon one of the 3D images during a different one of the phases, the deformation matrixes each including transformation vectors for returning the voxels from the deformed coordination locations to the original coordinate locations;
interpolating between the transformation vectors of consecutive phases associated with a given coordinate location within the deformable volume to generate an interpolated transformation vector;
retrieving voxel data from a primary 3D image at a voxel location referenced by the interpolated transformation vector; and
generating a sub-phase 3D image of the deformable volume between the consecutive phases.

2. The method of claim 1, further comprising rendering the 3D images and the sub-phase 3D image to a display.

3. The method of claim 1, further comprising generating a plurality of sub-phase 3D images of the deformable volume between a single pair of consecutive phases by applying a different weighting factor to the interpolating for each of the plurality of sub-phases.

4. The method of claim 1, wherein generating the deformation matrixes is executed within a central processing unit and generating the sub-phase 3D image is executed within a graphical processing unit (“GPU”).

5. The method of claim 4, further comprising:
applying a filter function to the primary 3D image to generate a primary 3D texture;
loading the primary volume texture into the GPU;
loading the transformation vectors of the consecutive phases into red (R), green (G), blue (B) buffers of the GPU; and
generating the sub-phase 3D image of the deformable volume between the consecutive phases by interpolating between the transformation vectors of the consecutive phases stored in the RGB buffers and retrieving the voxel data from the primary 3D texture stored in the GPU.

6. The method of claim 1, wherein generating the deformation matrixes and generating the sub-phases are both executed within a central processing unit (“CPU”) prior to transferring the sub-phase 3D image to a graphical processing unit.

7. The method of claim 1, wherein the primary 3D image has a higher voxel resolution than the other 3D images.

8. The method of claim 1, wherein the sub-phase 3D image of the deformable volume comprises a plurality of voxels having isotropic voxel spacing.

9. The method of claim 1, wherein the object comprises a portion of a human anatomy and the deformation motion comprises a respiratory motion or cardiac motion.

10. The method of claim 1, further comprising:
when the interpolated transformation vector references back to an intermediate position between adjacent voxels of the primary 3D image, then interpolating between first and second voxel data associated with the adjacent voxels to generate the voxel data.

11. A computer-readable storage medium that provides instructions that, if executed by a computer, will cause the computer to perform operations comprising:
accessing a plurality of 3-dimensional (“3D”) images of a deformable volume including an object during phases of a deformation motion, the 3D images including voxels, wherein a portion of the voxels move from original coordinate locations during a primary phase to deformed coordinate locations during each subsequent phase of the deformation motion;
generating deformation matrixes each based upon one of the 3D images during a different one of the phases, the deformation matrixes each including transformation vectors each referencing one of the original coordinate locations of the primary phase from where an associated voxel migrated during deformation;
interpolating between the transformation vectors of consecutive phases associated with a given coordinate location within the deformable volume to generate an interpolated transformation vector;
retrieving voxel data from a primary 3D image at a voxel location referenced by the interpolated transformation vector; and
generating a sub-phase 3D image of the deformable volume between the consecutive phases.

12. The computer-readable storage medium of claim 11, wherein the transformation vectors comprise coordinates, the computer-readable storage medium, further providing instructions that, if executed by the computer, will cause the computer to perform further operations, comprising:
loading the coordinates for the transformation vectors of the consecutive phases into red (R), green (G), blue (B) buffers of a graphical processing unit prior to interpolating between the transformation vectors within the GPU.

13. The computer-readable storage medium of claim 11, further providing instructions that, if executed by the computer, will cause the computer to perform further operations, comprising:
generating a plurality of sub-phase 3D images of the deformable volume between a single pair of consecutive phases by applying a different weighting factor to the interpolating for each of the plurality of sub-phases.

14. The computer-readable storage medium of claim 13, wherein interpolating between the transformation vectors of the consecutive phases associated with the given coordinate location comprises interpolating according to the following relation:
(X_{d},Y_{d},Z_{d})=step(j)*(Xᵢ,Yᵢ,Zᵢ)+(1−step(j))*(Xᵢ₊₁,Yᵢ₊₁,Zᵢ₊₁),
where (X_{d}, Y_{d}, Z_{d}) represents an interpolated transformation vector for the given coordinate location, step (j) represents the weighting factor, (Xᵢ, Yᵢ, Zᵢ) represents the transformation vector for the given coordinate location for phase (i), and (Xᵢ₊₁, Yᵢ₊₁, Zᵢ₊₁) represents the transformation vector for the given coordinate location for phase (i+1).

15. The computer-readable storage medium of claim 11, further providing instructions that, if executed by the computer, will cause the computer to perform further operations, comprising:
applying a filter function to the primary 3D image to generate a primary 3D texture;
loading the primary volume texture into a graphical processing unit (“GPU”);
loading the transformation vectors of the consecutive phases into red (R), green (G), blue (B) buffers of the GPU; and
generating the sub-phase 3D image of the deformable volume between the consecutive phases by interpolating between the transformation vectors of the consecutive phases stored in the RGB buffers and retrieving the voxel data from the primary 3D texture stored in the GPU.

16. The computer-readable storage medium of claim 11, wherein the primary 3D image has a higher voxel resolution than the other 3D images.

17. The computer-readable storage medium of claim 11, wherein the sub-phase 3D image of the deformable volume comprises a plurality of voxels having isotropic voxel spacing.

18. The computer-readable storage medium of claim 11, wherein the object comprises a portion of a human anatomy and the deformation motion comprises a respiratory motion or cardiac motion.

19. The method of claim 11, further comprising:
when the interpolated transformation vector references back to an intermediate position between adjacent voxels of the primary 3D image, then interpolating between first and second voxel data associated with the adjacent voxels to generate the voxel data.

20. An apparatus for volume rendering of a 4-dimensional (“4D”) deformable volume representing an object in motion, the apparatus comprising:
a memory unit to store a plurality of 3-dimensional (“3D”) images of a deformable volume including the object during phases of the deformation motion, the 3D images including voxels, wherein a portion of the voxels move from original coordinate locations during a primary phase to deformed coordinate locations during each subsequent phase of the deformation motion; and
one or more processors coupled to the memory unit to:
generate deformation matrixes each based upon one of the 3D images during a different one of the phases, the deformation matrixes each including transformation vectors indicating how to return the voxels from their deformed coordination locations to their original coordinate locations;
interpolate between the transformation vectors of consecutive phases associated with a given coordinate location within the deformable volume;
retrieve voxel data from a primary 3D image at a voxel location referenced by the interpolated transformation vector; and
generate a sub-phase 3D image of the deformable volume between consecutive phases.

21. The apparatus of claim 20, wherein the one or more processors comprise:
a central processing unit (“CPU”) to generate the deformation matrixes; and
a graphical processing unit (“GPU”) to generate the sub-phase 3D image.

22. The apparatus of claim 21, wherein the GPU is further coupled to generate a plurality of sub-phase 3D images of the deformable volume between a single pair of consecutive phases by applying a different weighting factor to the interpolating for each of the plurality of sub-phases.

23. The apparatus of claim 21, wherein the GPU is further coupled to:
apply a filter function to the primary 3D image to generate a primary 3D texture;
buffer the primary 3D texture within the GPU;
load the transformation vectors of the consecutive phases into red (R), green (G), blue (B) buffers of the GPU; and
generate the sub-phase 3D image of the deformable volume between the consecutive phases by interpolating between the transformation vectors of the consecutive phases stored in the RGB buffers and retrieving the voxel data from the primary 3D texture stored in the GPU.

24. The apparatus of claim 20, wherein the primary 3D image has a higher voxel resolution than the other 3D images.

25. The apparatus of claim 20, wherein the sub-phase 3D image of the deformable volume comprises a plurality of voxels having isotropic voxel spacing.
